(19) United States
(12) Patent Application Publication
(10) Pub. No.: US 2016/0216645 A1
(43) Pub. Date: Jul. 28, 2016

(54) APPARATUS FOR MANUFACTURING THERMAL TRANSFER PRINT SHEET, METHOD OF MANUFACTURING THERMAL TRANSFER PRINT SHEET, AND THERMAL TRANSFER PRINT SHEET

(71) Applicant: CASIO COMPUTER CO., LTD., Tokyo (JP)

(72) Inventor: Shinsuke Miura, Tokyo (JP)

(21) Appl. No.: 14/981,172

(22) Filed: Dec. 28, 2015

(30) Foreign Application Priority Data
Jan. 27, 2015 (JP) 2015-013190

(51) Int. Cl. G03G 15/16

(52) U.S. Cl. CPC G03G 15/16

(57) ABSTRACT

An image used for alignment of an image to be thermally transferred to a transfer target medium is transferred and fixed to a release sheet. Subsequently, the release sheet is sent to a two-sided printing conveyance unit and the front and back sides of the release sheet are reversed. Then, a mirror image of the image to be thermally transferred to the transfer target medium and a thermoplastic resin image overlaid on the mirror image are transferred and fixed to the release sheet. As a result, a thermal transfer print sheet including the release sheet, an alignment image layer, a mirror image layer, and a transfer base material layer is created.

### CROSS-REFERENCE TO RELATED APPLICATION

This application is based upon and claims the benefit of priority from the prior Japanese Patent Application No. 2015-013190, filed Jan. 27, 2015, the entire contents of which are incorporated herein by reference.

### BACKGROUND OF THE INVENTION

1. Field of the Invention

The present invention relates to an apparatus for manufacturing a thermal transfer print sheet, a method of manufacturing a thermal transfer print sheet, and a thermal transfer print sheet.

2. Description of the Related Art

Conventionally, as a method of printing a desired image or a design such as a logo on a transfer target medium such as a fabric product including a T-shirt, a sweat shirt, or work clothes, wood, or a metal plate, a method and an apparatus have been proposed by which a thermal transfer print sheet is created in which an image to be thermally transferred to a transfer target medium and a transfer base material have been fixed on a release sheet (refer to Japanese Patent Application Laid-Open (Kokai) Publication No. 2013-068862).

When an image is to be transferred to a transfer target medium such as a T-shirt, a thermal transfer print sheet is overlaid on the transfer target medium with its surface (hereinafter referred to as a front surface) where the transfer object (the image to be thermally transferred) has been fixed opposing the transfer target medium, and heat and pressure are applied from the rear surface of the thermal transfer print sheet by using an iron or the like, whereby the image is fixed on the transfer target medium.

FIG. 7 is a schematic view for describing typical steps for creating a thermal transfer print sheet and steps for transferring an image using a conventional technique. In step (a), a release sheet 22 is sent to a conveyance belt (not shown), as shown in FIG. 7. In step (b), a mirror image 60 of an image to be transferred and printed onto a transfer target medium such as a T-shirt and a mirror image 61a of a thermoplastic resin image in a transfer base material developed in the same shape as that of a normal image of the image to be transferred and printed are transferred to the release sheet 22 while being overlaid on its release surface, as shown in FIG. 7.

In step (c), the release sheet 22 on which the mirror image 60 and the mirror image 61a of the thermoplastic resin image in the transfer base material having the same shape as that of the mirror image 60 are overlapped and transferred is carried into a fixing section, and the mirror image 60 of the image to be transferred and printed and the mirror image 61a of the thermoplastic resin image are fixed on the transfer target medium by heating and pressurization, as shown in FIG. 7. More specifically, in the processing in the steps (a) to (c), a thermal transfer print sheet 62a is created which includes the release sheet 22, the mirror image 60, and the mirror image 61a of the thermoplastic resin image in the transfer base material having the same shape as that of the mirror image 60.

In step (d), the thermal transfer print sheet 62a is overlaid on a transfer target medium 64 such as a T-shirt with a mirror image formation surface 62a-1 opposing the transfer target medium 64 by use of, for example, a commercially available hot press machine 63, as shown in FIG. 7. Then, the thermal transfer print sheet 62a is made to adhere to the transfer target medium 64 via the mirror image 61a of the thermoplastic resin image in the same shape as that of the mirror image 60 such that the release sheet 22 can be released after being cooled by heating and pressurization from a rear surface 62a-2 of the mirror image formation surface 62a-1 of the thermal transfer print sheet 62a.

Note that the thermal transfer print sheet 62a and the mirror image 60 may be made to adhere to the transfer target medium 64 via the mirror image 61a of the thermoplastic resin image by manual ironing, without using the hot press machine 63.

When the release sheet 22 is manually released after the thermal transfer print sheet 62a is cooled to approximately room temperature, a transfer image 65a where the mirror image 60 has been changed to a normal image 60a is created on the transfer target medium 64 that is a printing target such as a T-shirt, as shown in step (e) of FIG. 7.

However, in the above-described conventional technique, in printing using the thermal transfer print sheet 62a, an image to be printed is positioned on the transfer target medium 64 side when the thermal transfer print sheet 62a is set on the transfer target medium 64 such as a T-shirt, and therefore is difficult to be transferred to an aimed position.

### SUMMARY OF THE INVENTION

In accordance with one aspect of the present invention, there is provided an apparatus for manufacturing a thermal transfer print sheet, comprising: a transfer and fixing section which transfers and fixes an image to a release sheet; and a control section which (i) causes the transfer and fixing section to transfer and fix an alignment image used for alignment of an image to be thermally transferred to a transfer target medium to the release sheet, and (ii) causes the transfer and fixing section to transfer and fix the image to be thermally transferred to the transfer target medium to a surface of the release sheet which is different from a surface to which the alignment image is transferred and fixed.

In accordance with another aspect of the present invention, there is provided a method of manufacturing a thermal transfer print sheet, the method comprising: transferring and fixing an alignment image, which is used for alignment of an image to be thermally transferred to a transfer target medium, to a release sheet; and transferring and fixing the image to a surface of the release sheet which is different from a surface to which the alignment image is transferred and fixed.

In accordance with another aspect of the present invention, there is provided a thermal transfer print sheet, comprising: a release sheet; an alignment image layer formed on the release sheet and used for alignment of an image to be thermally transferred to a transfer target medium; and a transfer base material layer made of thermoplastic resin and formed on a surface of the release sheet which is different from a surface on which the alignment image layer is formed.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more deeply understood by the detailed description below being considered together with the following drawings.

FIG. 1 is a cross-sectional view showing the internal structure of a thermal transfer print sheet creation apparatus according to an embodiment of the present invention;

FIG. 2 is a circuit block diagram showing a control device of the thermal transfer print sheet creation apparatus according to the present embodiment;

FIG. 3 is a schematic diagram for describing steps of creating a thermal transfer print sheet and steps of transferring an image according to the present embodiment;

FIG. 4 is a schematic diagram showing a thermal transfer print sheet created using a thermal transfer print sheet creation method according to the present embodiment;

FIG. 5 is a schematic diagram showing (on the upper side of the drawing) a relationship of an alignment image created using the thermal transfer print sheet creation method according to the present embodiment when a plurality of transfer objects are formed on a release sheet, and showing (on the lower side of the drawing) a state after some of the transfer objects are thermally transferred to a transfer target medium;

FIG. 6 is a conceptual diagram showing change in the surface condition of a toner with which printing on a rear surface has been performed for alignment in the thermal transfer print sheet creation method according to the present embodiment; and

FIG. 7 is a schematic diagram for describing typical steps of creating a thermal transfer print sheet and steps of transferring an image using a conventional technique.

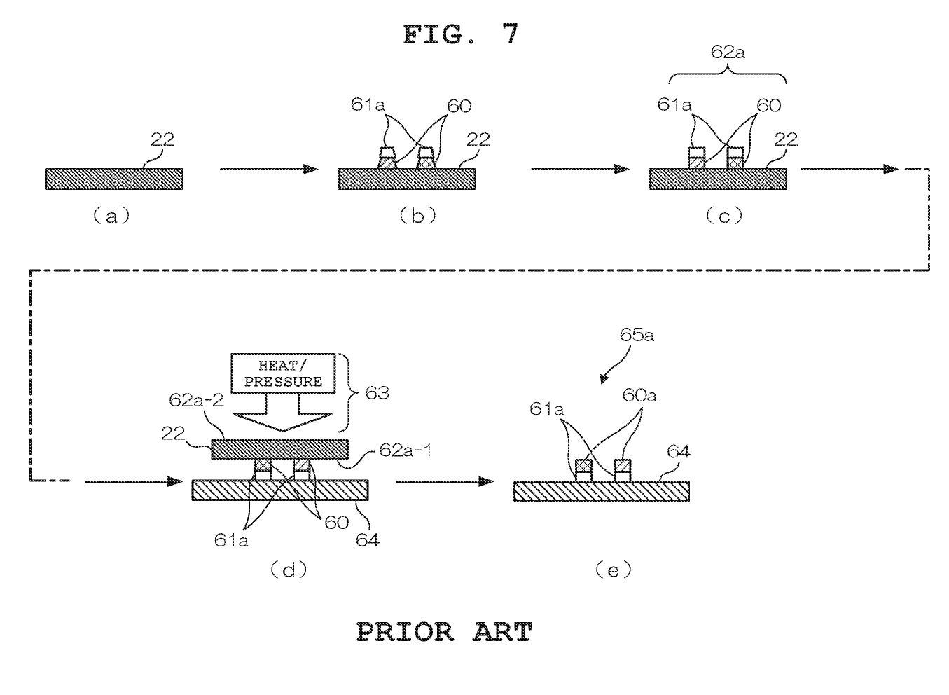

### DETAILED DESCRIPTION OF THE PREFERRED EMBODIMENT

An embodiment of the present invention will hereinafter be described with reference to the drawings.

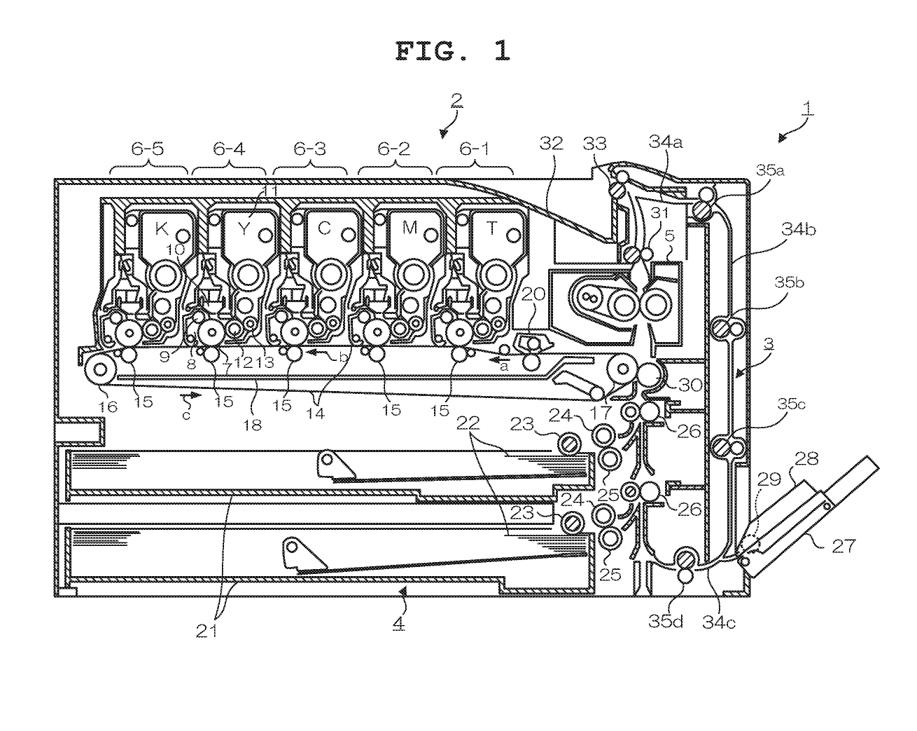

FIG. 1 is a cross-sectional view showing the internal structure of a thermal transfer print sheet creation apparatus 1 according to an embodiment of the present invention. The thermal transfer print sheet creation apparatus 1 of the present embodiment in FIG. 1 is not an apparatus that directly transfers a toner image to paper but an apparatus that transfers a toner image to an intermediate transfer belt once and secondarily transfers the toner image to paper vertically conveyed to a secondary transfer section via the intermediate transfer belt.

This thermal transfer print sheet creation apparatus 1 includes an image forming section 2, a two-sided printing conveyance unit 3, a sheet feeding section 4, and a fixing section 5. The image forming section 2 has a structure where five image forming units 6 (6-1, 6-2, 6-3, 6-4, and 6-5) have been provided side-by-side in multiple stages. The image forming unit 6-1 on the upper flow side in the paper conveyance direction (on the right side in the drawing) among the five image forming units 6 forms a toner image in a transfer base material (T) made of thermoplastic resin described below (a toner image developed on a photosensitive drum is hereinafter referred to as an image regardless of its shape).

The three image forming units 6-2, 6-3, and 6-4 subsequent to the above-described image forming unit 6-1 respectively form monochrome images with toners in magenta (M), cyan (C), and yellow (Y) serving as subtractive primary colors. The fifth image forming unit 6-5 subsequent to these three image forming units 6-2, 6-3, and 6-4 forms a monochrome image in black (K). The toner images in the four colors are overlaid on a release sheet (hereinafter referred to as paper in some cases) described below to form a full-color image.

The image forming units 6-1 to 6-5 respectively have the same structures except for the color and the type of a developer contained in a developing unit. Therefore, their structures will be described using the structure of the image forming unit 6-4 as an example.

The image forming unit 6 has a photosensitive drum 7 in its lowermost portion. The peripheral surface of this photosensitive drum 7 is formed of, for example, an organic photoconductive material, and a cleaner 8, a charging roller 9, an optical writing head 10, and a developing roller 12 in a developing device 11 are arranged to contact with the peripheral surface of the photosensitive drum 7 or surround the vicinity thereof.

The developing device 11 has in its upper portion a toner container containing the toner of one of the transfer base material (T), magenta (M), cyan (C), yellow (Y), and black (K) indicated by T, M, C, Y, and K in the drawing, and has in its intermediate portion a toner replenishing mechanism oriented downward.

The developing device 11 includes the above-described developing roller 12 in a lateral opening in its lower portion, and has in its inner portion a toner agitating member, a toner supply roller 13 for supplying toner to the developing roller 12, a doctor blade for regulating a toner layer on the developing roller 12 to a predetermined layer thickness, and the like. The optical writing head 10 on the apparatus body side is arranged in proximity to the upper surface of the photosensitive drum 7 between the charging roller 9 and the developing device 11.

Also, in an area near the lower surface of the photosensitive drum 7, an intermediate transfer belt 14 is arranged, and a primary transfer roller 15 is pressed toward the lower surface of the photosensitive drum 7 with the intermediate transfer belt 14 interposed therebetween.

The intermediate transfer belt 14 is an endless-shaped transfer belt constituted by a conductive sheet-like member made of resin containing conductive carbon or an ion conductive material and extending in a flat loop shape substantially from the left end to the right end at a center portion of the apparatus body in the drawing. The intermediate transfer belt 14 is stretched between a driving roller 16 and a driven roller 17, and is cyclically driven in the counterclockwise direction in the drawing by the driving roller 16 so as to cyclically move in the counterclockwise direction indicated by arrows a, b, and c in the drawing.

The photosensitive drum 7 rotates in the clockwise direction in the drawing. First, this photosensitive drum 7 is initialized when the peripheral surface of the photosensitive drum 7 is uniformly charged by electric charge from the charging roller 9. Subsequently, an electrostatic latent image is formed on the peripheral surface of the photosensitive drum 7 by optical writing from the optical writing head 10 based on printing information.

Then, the electrostatic latent image is changed to a toner image (developed) using toner contained in the developing device 11 by development processing by the developing roller 12. Subsequently, the toner image acquired by the development onto the peripheral surface of the photosensitive drum 7 is directly transferred (primarily transferred) to the belt surface of the intermediate transfer belt 14 by the primary transfer roller 15 along with the rotation of the photosensitive drum 7. Then, the intermediate transfer belt 14 is conveyed to a transfer position where transfer to the release sheet 22 is performed so as to further transfer (secondarily transfer) the toner image directly transferred (primarily transferred) to the belt surface.

A belt position control mechanism 18 in FIG. 1 includes a primary transfer roller 15 constituted by a conductive foamed sponge that is pressed against the lower peripheral surface of the photosensitive drum 7 via the intermediate transfer belt 14. This belt position control mechanism 18 rotationally moves the three primary transfer rollers 15 respectively corresponding to the three image forming units 6-2, 6-3, and 6-4 in magenta (M), cyan (C), and yellow (Y) in the same period with a hook-type support shaft as its center.

Also, the belt position control mechanism. 18 rotationally moves one primary transfer roller 15 corresponding to the image forming unit 6-5 in black (K) in a rotational movement period different from the period of the three primary transfer rollers 15 so that the intermediate transfer belt 14 comes in contact with or separates from the photosensitive drum 7. Similarly, the belt position control mechanism 18 rotationally moves the one primary transfer roller 15 corresponding to the image forming unit 6-1 serving as the transfer base material (T) in a rotational movement period different from the period of the three primary transfer rollers 15 so that the intermediate transfer belt 14 comes in contact with or separates from the photosensitive drum 7.

More specifically, the belt position control mechanism 18 switches the position of the intermediate transfer belt 14 to a position for a full-color mode (the primary transfer rollers 15 corresponding to the four image forming units 6-2 to 6-5 come in contact with the intermediate transfer belt 14), a position for a monochrome mode (only the primary transfer roller 15 corresponding to the image forming unit 6-5 comes in contact with the intermediate transfer belt 14), a position for a transfer base material mode (the primary transfer rollers 15 corresponding to all the five image forming units 6-1 to 6-5 come in contact with the intermediate transfer belt 14), and a position for a non-transfer mode (the primary transfer rollers 15 corresponding to all the five image forming units 6-1 to 6-5 separate from the intermediate transfer belt 14).

The sheet feeding section 4 includes two sheet cassettes 21 arranged in two upper and lower stages, and a large number of cut paper-like release sheets 22 are stored in one or both of the sheet cassettes 21 in the sheet feeding section 4. A paper extraction roller 23, a feed roller 24, a blowing roller 25, and a standby conveyance roller pair 26 are arranged in the vicinity of (at the right in the drawing) of each of the sheet feed ports of the two sheet cassettes 21.

The release sheets 22 are conveyed from the sheet cassette 21 one by one by one rotation of the paper extraction roller 23, and are fed to the standby conveyance roller pair 26 via the feed roller 24 and the blowing roller 25. In the present embodiment, an image (alignment image) used for alignment of an image to be thermally transferred to a transfer target medium is first transferred and fixed to a surface of the release sheet 22 not serving as a release surface, the front and back sides of the release sheet 22 are reversed using a two-sided printing function, and the image to be thermally transferred to the transfer target medium is transferred and fixed to the release surface of the release sheet 22. Therefore, the release sheet 22 is stored in the sheet cassette 21 with the surface not serving as the release surface of the release sheet 22 up and the release surface down.

Alternatively, when the number of thermal transfer print sheets to be created is small, the release sheet 22 is fed to the standby conveyance roller pair 26 via a sheet feeding roller 29 from above a Multi Paper Feeder (MPF) tray 28 mounted on an opened mounting section 27. In this case, the release sheet 22 is fed with the surface not serving as the release surface down and the release surface up.

A secondary transfer roller 30 in FIG. 1, which comes in pressure contact with the driven roller 17 via the intermediate transfer belt 14, is arranged in the paper conveyance direction (in the vertically upward direction in the drawing) of the standby conveyance roller pair 26. The intermediate transfer belt 14, the driven roller 17, and the secondary transfer roller 30 form a secondary transfer section where secondary transfer to the release sheet 22 is performed.

The fixing section 5 including a belt-type thermal fixing unit is arranged on the lower flow side (on the upper side in the drawing) of the secondary transfer section. A conveyance roller pair 31 which conveys paper after fixing from the fixing section 5, and a paper ejection roller pair 33 which ejects the conveyed paper to a paper ejection tray 32 formed on the upper surface of the apparatus are arranged on the further lower flow side of the fixing section 5.

The outer surface (right outer side surface in the drawing) of the two-sided printing conveyance unit 3 serves as an opening/closing member that is used as the right side cover of the thermal transfer print sheet creation apparatus 1. The two-sided printing conveyance unit 3 includes a return path branched in the right lateral direction in the drawing from a conveyance path in an intermediate portion between the conveyance roller pair 31 and the paper ejection roller pair 33.

This return path includes a start return path 34a, an intermediate return path 34b bent downward, an end return path 34c bent in the left lateral direction for conclusively reversing returned paper, and four return roller pairs 35a, 35b, 35c, and 35d arranged halfway in the return paths. An outlet of the end return path 34c connects to a conveyance path directed toward the standby conveyance roller pair 26 corresponding to the sheet cassette 21 in a lower area in the sheet feeding section 4.

Note that, although the thermal transfer print sheet creation apparatus 1 shown in FIG. 1 has a mechanism that secondarily transfers a toner image, which has been primarily transferred to the intermediate transfer belt 14, to the release sheet 22 via the intermediate transfer belt 14, the present invention is not limited thereto. The thermal transfer print sheet creation apparatus 1 may have a mechanism that directly transfers a toner image to the release sheet 22.

As described above, in the present embodiment, an image used for alignment of an image to be thermally transferred to a transfer target medium is transferred and fixed to a surface of the release sheet 22 not serving as a release surface, the front and back sides of the release sheet 22 are reversed using the two-sided printing function, and then the image to be thermally transferred to the transfer target medium is transferred and fixed to the release surface of the release sheet 22. Therefore, in the thermal transfer print sheet creation apparatus 1, a toner image (such as the toner whose remaining amount is the largest) serving as an image for alignment of an image to be thermally transferred to a transfer target medium is primarily transferred to the intermediate transfer belt 14 by one of the image forming units 6-2 to 6-5, and this toner image serving as the image for alignment is secondarily transferred to the surface of the release sheet 22 not serving as the release surface via the driven roller 17 and the secondary transfer roller 30.

Then, the release sheet 22 is conveyed to the fixing section 5, and the toner image is melted by heat and pressure while being crimped so that the toner image serving as the image for alignment is fixed thereon. The release sheet 22 to which the toner image serving as the alignment image has been transferred is ejected halfway on the paper ejection tray 32 side once by the conveyance roller pair 31 and the paper ejection roller pair 33, is reversed such that the rear end of the release sheet 22 is positioned at the forehead in the traveling direction by the paper ejection roller pair 33 rotated backward, and is fed into the two-sided printing conveyance unit 3 with the rear end of the release sheet 22 held in the paper ejection roller pair 33. Then, the release sheet 22 is conveyed to the standby conveyance roller pair 26 via the start return path 34a, the intermediate return path 34b, and the end return path 34c. That is, the release sheet 22 whose front and back sides have been reversed is fed to the driven roller 17 and the secondary transfer roller 30 so that the release surface is oriented toward the intermediate transfer belt 14.

Here, the image forming unit 6-1 first primarily transfers a thermoplastic resin image (hereinafter referred to as a toner image in some cases) in the transfer base material (T) made of thermoplastic resin to the intermediate transfer belt 14. Then, the image forming unit 6-2 primarily transfers a toner image in magenta (M) (an image to be thermally transferred to the transfer target medium) to the intermediate transfer belt 14, the image forming unit 6-3 primarily transfers a subsequent toner image in cyan (C) (an image to be thermally transferred to the transfer target medium) to the intermediate transfer belt 14, the image forming unit 6-4 primarily transfers a third toner image in yellow (Y) (an image to be thermally transferred to the transfer target medium) to the intermediate transfer belt 14, and the image forming unit 6-5 primarily transfers a toner image in black (K) (an image to be thermally transferred to the transfer target medium) to the intermediate transfer belt 14.

That is, the respective toner images in magenta (M), cyan (C), yellow (Y), and black (K) (the images to be thermally transferred to the transfer target medium) are primarily transferred to the intermediate transfer belt 14 with the toner image in the transfer base material (T) as the lowermost layer. Then, these respective toner images in magenta (M), cyan (C), yellow (Y), and black (K) (the images to be thermally transferred to the transfer target medium) are transferred to the release surface of the release sheet 22 fed to the driven roller 17 and the secondary transfer roller 30, with the toner image in the transfer base material (T) laminated thereon.

In this case as well, the release sheet 22 is conveyed to the fixing section 5, and the toner image is melted by heat and pressure while being crimped so that the toner image serving as the image to be thermally transferred to the transfer target medium is fixed thereon, as in the case when the toner image (such as the toner whose remaining amount is the largest) serving as the first alignment image is transferred. The release sheet 22 to which the toner image serving as the image to be thermally transferred to the transfer target medium has been transferred is ejected to the paper ejection tray 32 with the image formation surface down by the conveyance roller pair 31 and the paper ejection roller pair 33.

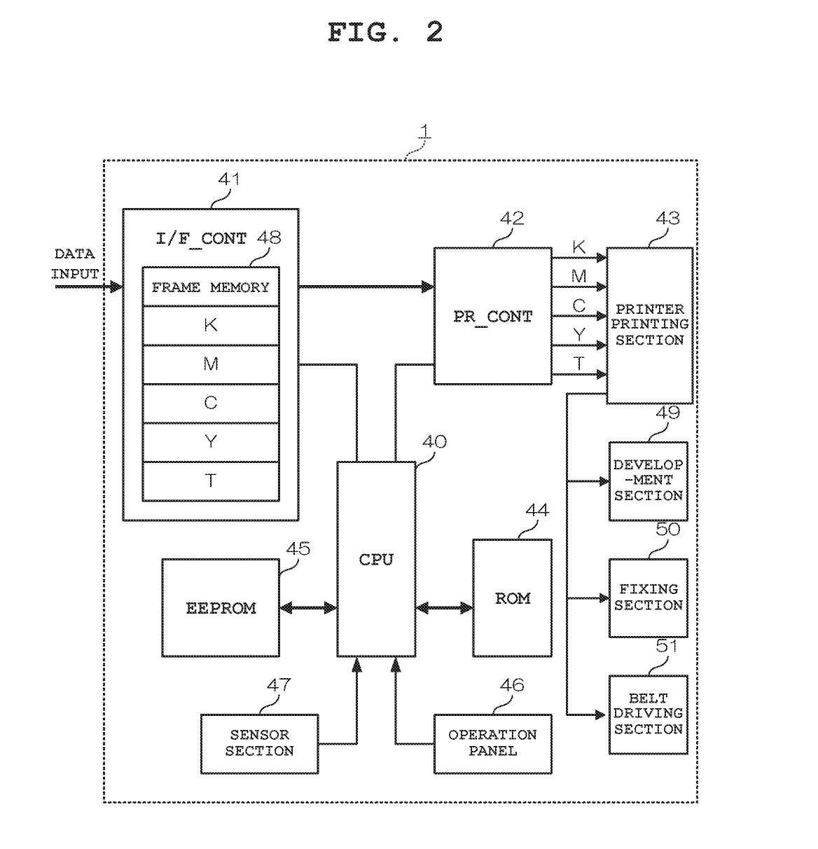

FIG. 2 is a circuit block diagram showing a control device of the thermal transfer print sheet creation apparatus 1 according to the present embodiment. In the circuit block, an interface controller (I/F_CONT) 41 and a printer controller (PR_CONT) 42 are respectively connected to a central processing unit (CPU) 40 via data buses with the CPU 40 as its center, and a printer printing section 43 is connected to the PR_CONT 42, as shown in FIG. 2.

Also, the CPU 40 has connected thereto a read only memory (ROM) 44, an electrically erasable programmable ROM (EEPROM) 45, an operation panel 46 in a main body operation section, and a sensor section 47 to which an output from a sensor arranged in each section are input.

The ROM 44 stores a system program, and the CPU 40 controls each section according to this system program to perform processing.

More specifically, in each section, the I/F_CONT 41 first converts print data to be provided from a host apparatus such as a personal computer into bit map data, and develops the bit map data into a frame memory 48.

The frame memory 48 includes storage areas set for black (K), magenta (M), cyan (C), yellow (Y), and the transfer base material (T), and respective data in these colors and the transfer base material are developed in the corresponding storage areas. The data developed in the frame memory 48 is outputted to the PR_CONT 42, and then outputted to the printer printing section 43 from the PR_CONT 42.

The printer printing section 43 has a rotation driving system (not shown) including the photosensitive drum 7 shown in FIG. 1, an image forming section including driven sections such as the charging roller 9 and the optical writing head 10, and a driving section (not shown) for driving the vertical movement of the intermediate transfer belt 14.

The printer printing section 43 supplies image data in the respective colors, which are black (K), magenta (M), cyan (C), and yellow (Y), and image data in the transfer base material to the corresponding optical writing heads 10 shown in FIG. 1. Also, the printer printing section 43 controls the formation of an electrostatic latent image on the photosensitive drum 7 based on image data by the optical writing head 10 and controls development with the toner of the color or the transfer base material corresponding to the formed electrostatic latent image via a development section 49.

Moreover, the printer printing section 43 controls driving output for performing various types of control such as the adjustment of a voltage applied to a heat generation section incorporated in a heat roller of the fixing section 5 and a pressure force of a pressing roller for pressing the heat roller via a fixing section 50. Furthermore, the printer printing section 43 controls driving output for performing the vertical movement of the belt position control mechanism 18 in the intermediate transfer belt 14 and the rotation driving of the driving roller 16 for circularly moving the intermediate transfer belt 14 via a belt driving section 51.

The CPU 40 generates an image used for alignment of an image to be thermally transferred to a transfer target medium based on image data in the respective colors, that is, black (K), magenta (M), cyan (C), and yellow (Y) stored in the frame memory 48. In addition, the CPU 40 outputs alignment image data to the PR_CONT 42 to cause a transfer section in one of the image forming units 6-2 to 6-5 to transfer a toner image (such as the toner whose remaining amount is the largest) serving as the image for alignment of the image to be thermally transferred to the transfer target medium to a surface of the release sheet 22 not serving as a release surface. Then, the PR_CONT 42 outputs the alignment image data to the printer printing section 43, and the printer printing section 43 supplies the alignment image data to the optical writing head 10 in one of the image forming units 6-2 to 6-5.

In addition, the CPU 40 controls the PR_CONT 42 so as to supply the release sheet 22 on which the alignment image has been transferred and fixed to the two-sided printing conveyance unit 3 and reverse the release sheet 22. Then, the CPU 40 controls the PR_CONT 42 so as to cause the transfer sections in the image forming units 6-2 to 6-5 to respectively transfer toner images in the respective colors to the release surface of the reversed release sheet 22 and further cause the transfer section in the image forming unit 6-1 to transfer a thermoplastic resin image in the transfer base material (T) made of thermoplastic resin.

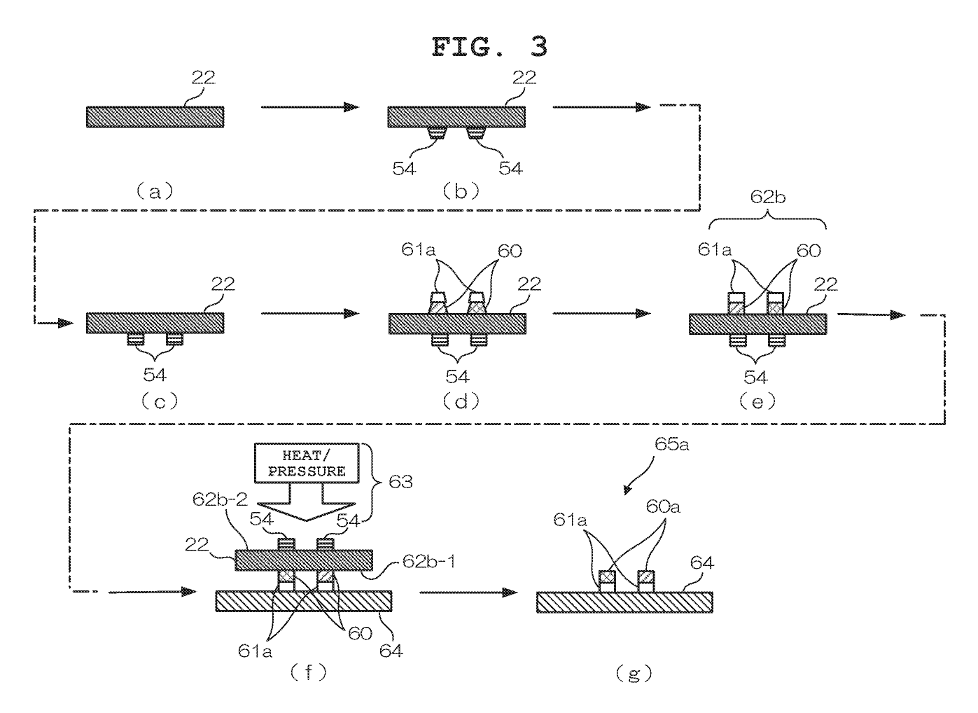

FIG. 3 is a schematic diagram for describing steps of creating a thermal transfer print sheet and steps of transferring an image according to the present embodiment. In step (a), the CPU 40 sends a non-transparent release sheet 22, as shown in FIG. 3. In step (b), the CPU 40 secondarily transfers, to a surface of the release sheet 22 not serving as a release surface, a toner image (such as the toner whose remaining amount is the largest) serving as an alignment image 54 for alignment of an image to be thermally transferred to a transfer target medium, which has been generated in one of the image forming units 6-2 to 6-5, as shown in FIG. 3. In the step (c), the CPU 40 carries the release sheet 22, in which the alignment image 54 has been secondarily transferred to the surface not serving as the release surface, into the fixing section 5, and fixes the toner image serving as the alignment image 54 by heating and pressurization, as shown in FIG. 3.

In step (d), the CPU 40 sends the release sheet 22 to the two-sided printing conveyance unit 3, reverses the front and back sides of the release sheet 22, and secondarily transfers to the release surface of the release sheet 22 a mirror image 60 acquired by reversing a normal image of an image to be transferred and printed onto the transfer target medium and a mirror image 61a of a thermoplastic resin image in the transfer base material developed having the same shape as that of the normal image of the image to be transferred and printed onto the transfer target medium, as shown in FIG. 3. In step (e), the CPU 40 carries the release sheet 22, on which the mirror image 60 of the image to be transferred and printed on the transfer target medium and the mirror image 61a of the thermoplastic resin image in the transfer base material having the same shape as that of the mirror image 60 have been secondarily transferred with the mirror image 61a overlaid on the mirror image 60, into the fixing section 5, and fixes the mirror image 60 of the image to be transferred and printed and the mirror image 61a of the thermoplastic resin image by heating and pressurization, as shown in FIG. 3.

When the mirror image 60 of the image to be transferred and printed and the alignment image 54 are printed at a position where they overlap with each other with the release sheet 22 interposed therebetween, the position of the image to be thermally transferred to the transfer target medium can be grasped from the back side of the release sheet 22. Through processing in the above-described (a) to (e) steps of FIG. 3, a thermal transfer print sheet 62b including the release sheet 22, the alignment image 54, the mirror image 60, and the mirror image 61a of the thermoplastic resin image in the transfer base material having the same shape as that of the mirror image 60 is created. This thermal transfer print sheet 62b is ejected to the paper ejection tray 32 with the image formation surface down by the conveyance roller pair 31 and the paper ejection roller pair 33 from the fixing section 5.

In step (f), the CPU 40 overlays the thermal transfer print sheet 62b on the transfer target medium 64 such as a T-shirt with a mirror image formation surface 62b-1 opposing the transfer target medium 64 using, for example, a commercially available hot press machine 63, as shown in FIG. 3. Here, the alignment image 54 is printed on the rear surface 62b-2 of the release sheet 22 not serving as the release surface. Thus, the thermal transfer print sheet 62b can be easily aligned with the transfer target medium 64 such as a T-shirt.

Then, the CPU 40 causes the thermal transfer print sheet 62b adhere to the transfer target medium 64 via the mirror image 61a of the thermoplastic resin image in the same shape as that of the mirror image 60 so that the release sheet 22 can be released after being cooled by heating and pressurization from the rear surfaces 62a-2 of the mirror image formation surface 62b-1 of the thermal transfer print sheet 62b.

Note that the CPU 40 may cause the thermal transfer print sheet 62a and the mirror image 60 to adhere to the transfer target medium 64 via the mirror image 61a of the thermoplastic resin image by manual ironing without using the hot press machine 63.

When the release sheet 22 is manually released after the thermal transfer print sheet 62b is cooled down to approximately room temperature, a transfer image 65a, in which the mirror image 60 has been changed to a normal image 60a, is created on the transfer target medium 64 serving as a printing target such as a T-shirt, as shown in step (g) of FIG. 3.

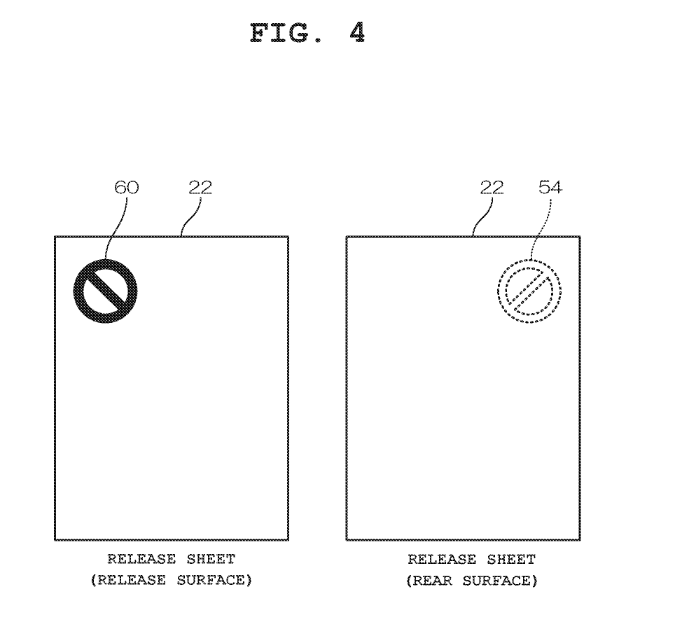

FIG. 4 is a schematic diagram showing a thermal transfer print sheet 62b created using the thermal transfer creation method according to the present embodiment. A mirror image 60 of an image to be transferred and printed onto a transfer target medium 64 is printed on a release surface of a release sheet 22, and an alignment image 54 constituted by a normal image of the image to be transferred and printed is printed on a surface of the release sheet 22 not serving as the release surface (a rear surface) at a position where it overlaps with the mirror image 60 of the image to be transferred and printed.

As described above, in the present embodiment, the alignment image 54 is printed on the surface (the rear surface) of the release sheet 22 not serving as the release surface at the position where it overlaps with the mirror image 60 of the image to be transferred and printed, by using the two-sided printing function of the thermal transfer print sheet creation apparatus 1, as shown in step (d) of FIG. 3. As a result of this configuration, the position of an image to be thermally transferred to the transfer target medium 64 can be grasped even from the back side of the thermal transfer print sheet 62b, as shown in FIG. 4.

Note that the alignment image 54 may be a contour of the normal image of the image to be transferred and printed onto the transfer target medium 64 on the rear surface of the release sheet 22, as shown in FIG. 4. When only the contour of the image to be thermally transferred onto the transfer target medium 64 is printed because the position of the alignment image 54 is graspable, as shown in FIG. 4, useless toner consumption can be suppressed as much as possible. Here, among toners for image formation which are used for the alignment image 54, the toner whose remaining amount is the largest should preferably be used.

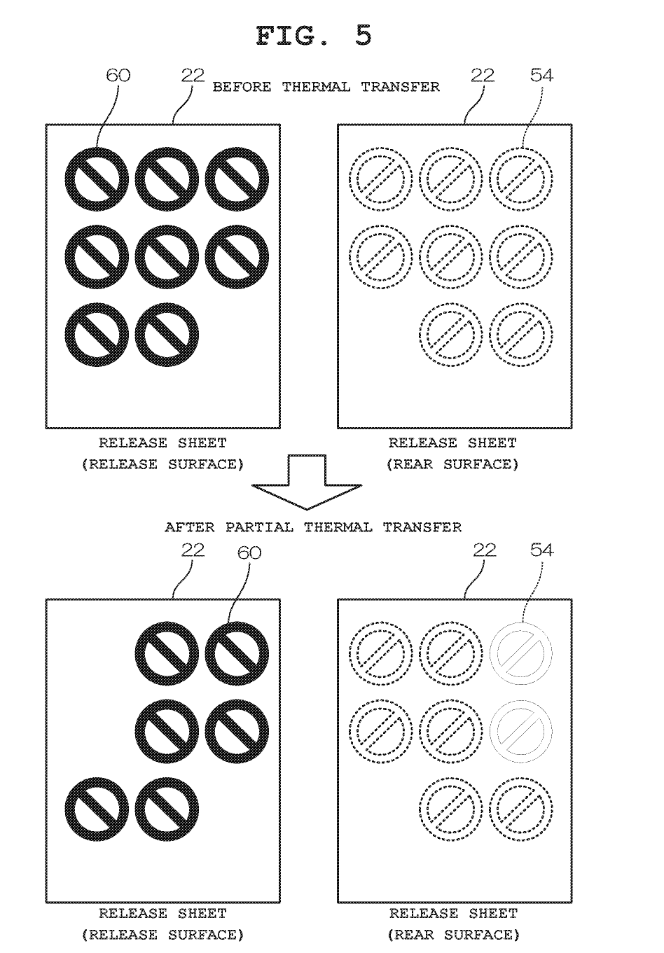

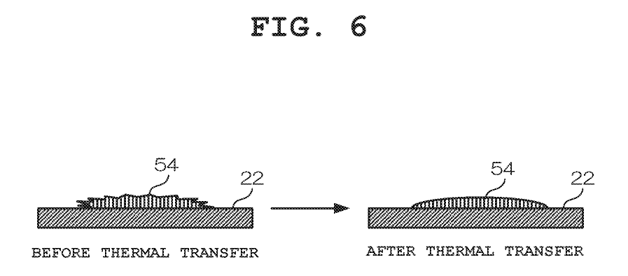

FIG. 5 is a schematic diagram showing (on the upper side of the drawing) a relationship of alignment images 54 created using the thermal transfer print sheet creation method according to the present embodiment when a plurality of objects to be transferred (images to be thermally transferred to a transfer target medium 64) are formed on one release sheet 22, and a schematic diagram showing (on the lower side of the drawing) a state after some of the objects to be transferred are thermally transferred to the transfer target medium 64. FIG. 6 is a conceptual diagram showing change in the surface condition of a toner with which printing on the rear surface of the release sheet 22 has been performed for alignment in the thermal transfer print sheet creation method according to the present embodiment.

In the present embodiment, if heat and pressure are applied to the alignment image 54 using an iron or the like when an image to be transferred and printed is transferred to the transfer target medium 64, the surface condition of a toner with which printing on the rear surface has been performed for alignment becomes flatter, as shown in FIG. 6. Accordingly, glossiness on the surface of the toner increases. Since the surface condition of the toner changes, it can be easily and visually recognized whether thermal transfer has been performed.

That is, as shown in FIG. 5, if the plurality of objects to be transferred (the mirror images 60 of the images to be thermally transferred to the transfer target medium 64) are formed on the one release sheet 22, a difference between the alignment image 54 on a portion of the release sheet 22 where thermal transfer has been performed, and the alignment image 54 on a portion of the release sheet 22 where thermal transfer has not been performed is found. Accordingly, it can be easily grasped to which portion of the alignment sheet 22 the thermal transfer has been performed from the rear surface of the thermal transfer print sheet 62b.

According to the above-described embodiment, the alignment image 54 is printed on the rear surface of the thermal transfer print sheet 62b such that it overlaps with the mirror image 60 of an image to be transferred and printed via the thermal transfer print sheet 62b. As a result of this configuration, alignment with the transfer target medium 64 can be easily performed without requiring processing for cutting out only an image area. In addition, the alignment with the transfer target medium 64 can be easily performed without using a transparent release sheet that is expensive and having poor fixability.

Also, according to the above-described embodiment, only the contour of the alignment image 54 is printed in a single color. As a result of this configuration, toner consumption can be suppressed as much as possible. In addition, by only the contour of the alignment image 54 being printed, toner consumption can be further suppressed as much as possible.

Moreover, according to the above described-embodiment, even if there are plural images to be thermally transferred onto the transfer target medium 64 on one sheet, the alignment of the sheet with the transfer target medium 64 can be easily performed. In addition, since a toner used for the alignment image 54 on the rear surface of the sheet changes in appearance after the thermal transfer, it can be easily identified up to which of the images the thermal transfer has been performed from the rear surface.

While the present invention has been described with reference to the preferred embodiments, it is intended that the invention be not limited by any of the details of the description therein but includes all the embodiments which fall within the scope of the appended claims.

What is claimed is:

1. An apparatus for manufacturing a thermal transfer print sheet, comprising:
a transfer and fixing section which transfers and fixes an image to a release sheet; and
a control section which (i) causes the transfer and fixing section to transfer and fix an alignment image used for alignment of an image to be thermally transferred to a transfer target medium to the release sheet, and (ii) causes the transfer and fixing section to transfer and fix the image to be thermally transferred to the transfer target medium to a surface of the release sheet which is different from a surface to which the alignment image is transferred and fixed.

2. The apparatus according to claim 1, wherein the control section (i) causes the transfer and fixing section to transfer and fix the alignment image used for alignment of the image to be thermally transferred to the transfer target medium to the release sheet, (ii) reverses the front and back sides of the release sheet, and (iii) causes the transfer and fixing section to transfer and fix the image to be thermally transferred to the transfer target medium to the surface of the release sheet which is different from the surface to which the alignment image has been transferred and fixed.

3. The apparatus according to claim 1, wherein the control section (i) causes the transfer and fixing section to transfer and fix the alignment image used for alignment of the image to be thermally transferred to the transfer target medium to a surface of the release sheet which is not serving as a release surface, and (ii) causes the transfer and fixing section to transfer and fix the image to be thermally transferred to the transfer target medium to the release surface of the release sheet.

4. The apparatus according to claim 1, wherein the alignment image is an image representing a contour of the image to be thermally transferred to the transfer target medium.

5. The apparatus according to claim 1, wherein the alignment image is a mirror image of the image to be thermally transferred to the transfer target medium, and positions of both images on the front and back sides of the release sheet overlap with each other.

6. The apparatus according to claim 1, wherein the alignment image is printed in a single color of a toner whose remaining amount is the largest among toners for image formation.

7. The apparatus according to claim 1, wherein the alignment image is printed with a toner whose surface characteristic changes before and after thermal transfer processing on the transfer target medium by directly receiving heat and pressure in the thermal transfer processing.

8. A method of manufacturing a thermal transfer print sheet, the method comprising:
transferring and fixing an alignment image, which is used for alignment of an image to be thermally transferred to a transfer target medium, to a release sheet; and
transferring and fixing the image to a surface of the release sheet which is different from a surface to which the alignment image is transferred and fixed.

9. A thermal transfer print sheet, comprising:
a release sheet;
an alignment image layer formed on the release sheet and used for alignment of an image to be thermally transferred to a transfer target medium; and
a transfer base material layer made of thermoplastic resin and formed on a surface of the release sheet which is different from a surface on which the alignment image layer is formed.
